(19) United States
(12) Patent Application Publication
(10) Pub. No.: US 2014/0294657 A1
(43) Pub. Date: Oct. 2, 2014

(54) PROCESS FOR PRODUCING FERROMAGNETIC IRON NITRIDE PARTICLES, ANISOTROPIC MAGNET, BONDED MAGNET AND COMPACTED MAGNET

(71) Applicants: TOHOKU UNIVERSITY, Sendai-shi, Miyagi-ken (JP); TODA KOGYO CORP, Otake-shi, Hiorshima-ken (JP)

(72) Inventors: Shinpei Yamamoto, Hirakata-shi (JP); Mikio Takano, Kyoto-shi (JP); Migaku Takahashi, Sendai-shi (JP); Tomoyuki Ogawa, Sendai-shi (JP); Naoya Kobayashi, Otake-shi (JP)

(21) Appl. No.: 14/346,338

(22) PCT Filed: Sep. 20, 2012
(86) PCT No.: PCT/JP2012/074045

§ 371 Date: Mar. 21, 2014

(30) Foreign Application Priority Data
Sep. 22, 2011 (JP) 2011-208189
Sep. 22, 2011 (JP) 2011-208199

(51) Int. Cl. H01F 1/24; B22F 1/02

(52) U.S. Cl. CPC H01F 1/24; B22F 1/02
USPC 419/66; 148/230

(57) ABSTRACT

The present invention provides ferromagnetic iron nitride particles, in particular, in the form of fine particles, and a process for producing the ferromagnetic iron nitride particles. The present invention relates to a process for producing ferromagnetic iron nitride particles, comprising the steps of mixing metallic iron obtained by mixing at least one compound selected from the group consisting of a metal hydride, a metal halide and a metal borohydride with an iron compound, and then subjecting the obtained mixture to heat treatment, with a nitrogen-containing compound; and then subjecting the resulting mixture to heat treatment, in which a reduction step and a nitridation step of the iron compound are conducted in the same step, and the at least one compound selected from the group consisting of a metal hydride, a metal halide and a metal borohydride is used as a reducing agent in the reduction step, whereas the nitrogen-containing compound is used as a nitrogen source in the nitridation step.

### TECHNICAL FIELD

The present invention relates to a process for producing ferromagnetic iron nitride particles, in particular, fine ferromagnetic iron nitride particles. In addition, the present invention relates to an anisotropic magnet, a bonded magnet and a compacted magnet obtained using the ferromagnetic iron nitride particles produced by the above production process.

### BACKGROUND ART

At present, as a magnet for motors requiring a power torque which are used in various applications including not only hybrid cars and electric cars but also familiar domestic appliances such as air conditioners and washing machines, there have been used Nd—Fe—B-based magnetic particles and a molded product thereof. However, the use of the Nd—Fe—B-based magnetic material as a magnet in these applications has almost reached a theoretical limitation.

In addition, supply of rare earth elements as the raw materials largely depends upon import from China in view of low costs of the raw materials and a low content of isotope elements in the raw materials, i.e., there is present the large problem of so-called “China risk”. For this reason, Fe—N-based compounds such as Fe₁₆N₂ comprising no rare earth elements have been noticed.

Among the Fe—N-based compounds, α″-Fe₁₆N₂ is known as a metastable compound that is crystallized when subjecting a martensite or a ferrite comprising nitrogen in the form of a solid solution therein to annealing treatment for a long period of time. The α″-Fe₁₆N₂ has a “bct” crystal structure, and therefore it is expected that the α″-Fe₁₆N₂ provides a giant magnetic substance having a large saturation magnetization. However, as understood from the name “metastable compound”, there have been reported only very few successful cases where the compounds could be chemically synthesized in the form of isolated particles.

Hitherto, in order to obtain an α″-Fe₁₆N₂ single phase, various methods such as a vapor deposition method, an MBE method (molecular beam epitaxy method), an ion implantation method, a sputtering method and an ammonia nitridation method have been attempted. However, production of more stabilized γ′-Fe₄N or ε-Fe₂₋₃N is accompanied with an eutectic crystal of martensite (α′-Fe)-like metal or ferrite (α-Fe)-like metal, which tends to cause difficulty in producing the α″-Fe₁₆N₂ single phase compound in an isolated state. In some cases, it has been reported that the α″-Fe₁₆N₂ single phase compound is produced in the form of a thin film. However, the α″-Fe₁₆N₂ single phase compound in the form of such a thin film may be applied to magnetic materials only in a limited range, and therefore tends to be unsuitable for use in more extensive application fields.

The following known techniques concerning the α″-Fe₁₆N₂ have been proposed.

### CITATION LIST

### Patent Literatures

Patent Document 1: Japanese Patent Application Laid-Open (KOKAI) No. 11-340023
Patent Document 2: Japanese Patent Application Laid-Open (KOKAI) No. 2000-277311
Patent Document 3: Japanese Patent Application Laid-Open (KOKAI) No. 2009-84115
Patent Document 4: Japanese Patent Application Laid-Open (KOKAI) No. 2008-108943
Patent Document 5: Japanese Patent Application Laid-Open (KOKAI) No. 2008-103510
Patent Document 6: Japanese Patent Application Laid-Open (KOKAI) No. 2007-335592
Patent Document 7: Japanese Patent Application Laid-Open (KOKAI) No. 2007-258427
Patent Document 8: Japanese Patent Application Laid-Open (KOKAI) No. 2007-134614
Patent Document 9: Japanese Patent Application Laid-Open (KOKAI) No. 2007-36027
Patent Document 10: Japanese Patent Application Laid-Open (KOKAI) No. 2009-249682

### Non-Patent Literatures

Non-Patent Document 1: M. Takahashi, H. Shoji, H. Takahashi, H. Nashi, T. Wakiyama, M. Doi and M. Matsui, “J. Appl. Phys.”, Vol. 76, pp. 6642-6647, 1994.
Non-Patent Document 2: Y. Takahashi, M. Katou, H. Shoji and M. Takahashi, “J. Magn. Magn. Mater.”, Vol. 232, pp. 18-26, 2001.

### SUMMARY OF THE INVENTION

### Problem to be Solved by the Invention

However, the techniques described in the above Patent Documents 1 to 11 and Non-Patent Documents 1 and 2 have still failed to achieve sufficient improvement in properties of the magnetic materials.

That is, in Patent Document 1, it is described that iron particles on which a surface oxide film is present are subjected to reducing treatment and then to nitridation treatment to obtain Fe₁₆N₂. However, in the Patent Document 1, it is not taken into consideration to enhance a maximum energy product of the material. In addition, in Patent Document 1, it is required that the nitridation reaction is conducted for a prolonged period of time. Therefore, the technique described in Patent Document 1 has failed to provide an industrially suitable process.

Also, in Patent Document 2, it is described that iron oxide particles are subjected to reducing treatment to produce metallic iron particles, and the resulting metallic iron particles are subjected to nitridation treatment to obtain Fe₁₆N₂. However, in Patent Document 2, the resulting particles are used as magnetic particles for magnetic recording media and therefore tend to be unsuitable as a hard magnetic material that is required to have a high maximum energy product BHₘₐₓ.

Also, in Patent Documents 3 to 9, there are described giant magnetic substances for magnetic recording materials which can be used instead of ferrite. However, the magnetic substances are produced in the form of not an α″-FeN₁₆N₂ single phase but a mixed phase of still stabler γ′-Fe₄N or ε-Fe₂₋₃N, and martensite (α′-Fe)-like metal or ferrite (α-Fe)-like metal.

Also, in Patent Document 10, it is described that the use of additive elements is essential, but there are no detailed discussions concerning the need for the additive elements. Further, the obtained product tends to be unsuitable as a hard magnetic material that is required to have a high maximum energy product BHₘₐₓ, in view of magnetic properties thereof.

In Non-Patent Documents 1 and 2, the α″-Fe₁₆N₂ single phase has been successfully produced in the form of a thin film. However, the α″-Fe₁₆N₂ single phase in the form of such a thin film is usable only in limited applications, and therefore unsuitable for use in more extensive applications. Further, these conventional materials have problems concerning productivity and economy when producing a generally used magnetic material therefrom.

In consequence, an object of the present invention is to provide a process for producing ferromagnetic iron nitride particles which is capable of readily producing ferromagnetic iron nitride (Fe₁₆N₂) particles, in particular, in the form of fine particles.

### Means for Solving the Problem

The above conventional problems can be solved by the following aspects of the present invention.

That is, according to the present invention, there is provided a process for producing ferromagnetic iron nitride particles, comprising the steps of:

mixing metallic iron or an iron compound with a nitrogen-containing compound; and

then subjecting the resulting mixture to heat treatment (Invention 1).

Also, according to the present invention, there is provided the process for producing ferromagnetic iron nitride particles as described in the above Invention 1, wherein the metallic iron is mixed with the nitrogen-containing compound, and the metallic iron has an average particle major axis length of 5 to 300 nm (Invention 2).

Also, according to the present invention, there is provided the process for producing ferromagnetic iron nitride particles as described in the above Invention 2, wherein the metallic iron is obtained by mixing at least one compound selected from the group consisting of a metal hydride, a metal halide and a metal borohydride with the iron compound, and then subjecting the resulting mixture to heat treatment (Invention 3).

Also, according to the present invention, there is provided the process for producing ferromagnetic iron nitride particles as described in the above Invention 2 or 3, wherein the metallic iron is coated with a silica layer having a thickness of not more than 20 nm (Invention 4).

Also, according to the present invention, there is provided the process for producing ferromagnetic iron nitride particles as described in the above Invention 1, wherein the iron compound, the nitrogen-containing compound, and a reducing agent are mixed with each other, and then the resulting mixture is subjected to heat treatment (Invention 5).

Also, according to the present invention, there is provided the process for producing ferromagnetic iron nitride particles as described in the above Invention 5, wherein a reduction step and a nitridation step of the iron compound are conducted in the same step (Invention 6).

Also, according to the present invention, there is provided the process for producing ferromagnetic iron nitride particles as described in the above Invention 5 or 6, wherein the at least one compound selected from the group consisting of a metal hydride, a metal halide and a metal borohydride is used as a reducing agent in the reduction step, and the nitrogen-containing compound is used as a nitrogen source in the nitridation step (Invention 7).

Also, according to the present invention, there is provided the process for producing ferromagnetic iron nitride particles as described in any one of the above Inventions 5 to 7, wherein the iron compound is a silica-coated iron compound (Invention 8).

In addition, according to the present invention, there is provided a process for producing an anisotropic magnet comprising ferromagnetic iron nitride particles, in which the ferromagnetic iron nitride particles produced by the process as described in any one of the above Inventions 1 to 8 are used (Invention 9).

Further, according to the present invention, there is provided a process for producing a bonded magnet comprising ferromagnetic iron nitride particles, in which the ferromagnetic iron nitride particles as defined in any one of the Inventions 1 to 8 are used (Invention 10).

Furthermore, according to the present invention, there is provided a process for producing a compacted magnet comprising ferromagnetic iron nitride particles, in which the ferromagnetic iron nitride particles produced by the process as defined in any one of the Inventions 1 to 8 are used (Invention 11).

### Effect of the Invention

In the process for producing ferromagnetic iron nitride particles according to the present invention, it is possible to readily produce the ferromagnetic iron nitride particles, in particular, the fine ferromagnetic iron nitride particles, and therefor the production process is suitable as a process for producing ferromagnetic iron nitride particles. In particular, since the nitrogen-containing compound is used in the nitridation step, a nitridation efficiency of the iron compound is extremely excellent as compared to the conventional gas-phase nitridation treatment, and the reduction step and the nitridation step of the iron compound can be conducted at the same time. Therefore, the production process of the present invention has an extremely high value as an industrial production process.

### Preferred Embodiments for Carrying Out the Invention

The process for producing ferromagnetic iron nitride particles according to the present invention comprises the steps of mixing metallic iron or an iron compound with a nitrogen-containing compound, and then subjecting the resulting mixture to heat treatment. In particular, the present invention is characterized by using the nitrogen-containing compound, and the production process of the present invention is classified into two kinds of processes in view of the reaction with the nitrogen-containing compound, i.e., the process in which the metallic iron having a specific average particle major axis length is used and reacted with the nitrogen-containing compound (Invention 2) or the process in which the iron compound and the reducing agent are reacted with the nitrogen-containing compound (Invention 5). The process concerning Invention 2 and the process concerning Invention 5 are respectively described below, but the following descriptions or explanations are common to both the processes unless otherwise noted.

First, the process concerning Invention 2 is described.

First, the metallic iron used in the process of Invention 2 is described.

The metallic iron raw material used in the process of Invention 2 has an average particle major axis length of 5 to 300 nm. When the average particle major axis length of the metallic iron is less than 5 nm, a large number of iron atoms tend to be present to be in contact with an interface between surfaces of the particles, so that it is not expected to obtain ferromagnetic iron nitride particles having a large magnetization therefrom. When the average particle major axis length of the metallic iron is more than 300 nm, the nitridation tends to hardly proceed, so that the metallic iron or Fe₄N tends to be included in the obtained particles. The average particle major axis length of the metallic iron is preferably 5 to 275 nm, and more preferably 6 to 265 nm.

The metallic iron raw material used for obtaining the ferromagnetic iron nitride particles according to the process of Invention 2 may be produced by a polyol method, an IBM method, a micelle/reverse micelle method, a precipitation method, etc., though not particularly limited thereto. Also, the metallic iron raw material may be produced by reducing an iron compound with hydrogen, etc.

For example, the metallic iron raw material used in the process of Invention 2 may be produced by mixing at least one compound selected from the group consisting of a metal hydride, a metal halide and a metal borohydride (reducing agent) with the iron compound, and then subjecting the resulting mixture to heat treatment. Specific examples of the reducing agent include metal hydrides such as dimethyl aluminum hydride, diisobutyl aluminum hydride, calcium hydride, magnesium hydride, sodium hydride, potassium hydride, lithium hydride, titanium hydride and zirconium hydride; metal halides such as magnesium borohydride and sodium borohydride; and metal borohydrides such as isopropyl magnesium halide, gallium halide, indium halide, tin halide, zinc halide, cadmium halide, copper halide, nickel halide, manganese halide and sodium aluminum halide. These reducing agents may be used alone or in combination of any two or more thereof. When two or more reducing agent are used, the proportion therebetween is not particularly limited.

Examples of the iron compound include, but are not particularly limited to, α-FeOOH, β-FeOOH, γ-FeOOH, α-Fe₂O₃, β-Fe₂O₃, Fe₂O₃, γ-Fe₂O₃, iron oxalate, iron acetate, iron nitrate, iron stearate and iron oleate. As the iron compound, there may be used different kinds of iron compounds, or there may be used two or more kinds of iron compounds. When two or more kinds of iron compounds are used, the proportion therebetween are not particularly limited. The shape of the iron compound is not particularly limited, and may be any of an acicular shape, a spindle shape, a rice grain shape, a spherical shape, a granular shape, a hexahedral shape, an octahedral shape, etc.

When using iron oxyhydroxide as the iron compound, the oxyhydroxide may be subjected to dehydration treatment, if required. The temperature of the dehydration treatment is preferably 80 to 350° C. When the temperature of the dehydration treatment is lower than 80° C., substantially no dehydration tends to proceed. When the temperature of the dehydration treatment is higher than 350° C., it may be difficult to obtain metallic iron particles at a low temperature in the subsequent reducing treatment. The temperature of the dehydration treatment is preferably 85 to 300° C.

The reducing agent is suitably in the form of particles that are dry-mixed with the metallic iron particles. It is preferred that the metallic iron particles and the reducing agent are previously pulverized and mixed in a mortar, etc.

In addition, in particular, in the case where the reducing agent comprises water or a considerable amount of water is absorbed in the reducing agent, it is preferred that the reducing agent is previously subjected to drying or preheating treatment.

The mixing ratio between the metallic iron particles and the reducing agent is not particularly limited, and the weight ratio of the reducing agent to the metallic iron particles is 0.5 to 20, and preferably 0.8 to 10.

The purity of the reducing agent is not particularly limited, for example, is in the range of 50 to 99% and preferably 60 to 96% in view of a good balance between effectiveness and costs of the reducing agent.

The heat treatment of a mixture of the metallic iron particles and the reducing agent may be conducted by either a standing method or a flowing method, and is preferably performed in a sealed container. In a laboratory level, there may be used, for example, the method in which a mixture of the metallic iron particles and the reducing agent is filled and sealed in a glass tube. Also, in a pilot scale, there may be used the method in which a mixture of the metallic iron particles and the reducing agent is filled and sealed in a metal tube and subjected to heat treatment while flowing therein.

The temperature of the heat treatment of the mixture of the metallic iron particles and the reducing agent is 50 to 280° C. The heat treatment temperature may be appropriately determined according to kind and amount of the reducing agent added, and a reducing temperature inherent to the respective metal compounds, and is preferably 80 to 275° C. and more preferably 100 to 250° C. Also, the heat treatment time is preferably 0.5 h to 7 days, and more preferably 1 h to 3 days.

The metallic iron used in the process of Invention 2 may be coated with silica. The thickness of the silica coating layer is not more than 20 nm, and preferably not more than 17 nm.

Examples of the nitrogen-containing compound used in the process of Invention 2 include, but are not particularly limited to, urea, ammonia water, ammonium chloride, nitric acid, methylamine, dimethylamine, ethylamine, piperazine, aniline, sodium amide, lithium diisopropyl amide, potassium amide or the like, which may be used in the form of either a solid or a liquid. These nitrogen-containing compounds may be used alone or in combination of any two or more thereof. When using two or more kinds of nitrogen-containing compounds, the proportion therebetween is not particularly limited. Among these nitrogen-containing compounds, preferred are inorganic metal amide compounds and organic amine compounds, and especially preferred are inorganic metal amide compounds.

The process for producing the ferromagnetic iron nitride particles according to the process of Invention 2 includes the steps of subjecting the metallic iron having an average particle major axis length of 5 to 300 nm and the nitrogen-containing compound to heat treatment at a temperature of not higher than 200° C., and then washing the resulting particles.

When the heat treatment temperature of the mixture of the metallic iron and the nitrogen-containing compound is higher than 200° C., different kinds of phases such as Fe₄N tend to be included in the resulting particles. The heat treatment temperature is preferably 100 to 200° C. and more preferably 100 to 190° C. The heat treatment time is not particularly limited, and is preferably 3 to 120 h and more preferably 3 to 100 h.

The washing treatment may be carried out using dehydrated ethanol or methanol, though not particularly limited thereto. The amount of a washing solvent used for the washing treatment is not particularly limited, and the solvent may be used in an amount of not less than 100 mL per 1 g of the ferromagnetic iron nitride particles. The washing method is not particularly limited, and the washing treatment may be conducted by any method using a Nutsche, a press filter, a glass filter, a centrifugal separator or the like. The drying may be appropriately carried out by natural drying, vacuum drying, (vacuum) freeze drying, etc., or using an evaporator.

The average major axis length of the ferromagnetic iron nitride particles produced by the production process of Invention 2 is 5 to 300 nm. The shape of the ferromagnetic iron nitride particles is not particularly limited, and may be any of an acicular shape, a spindle shape, a rice grain shape, a spherical shape, a granular shape, a hexahedral shape, an octahedral shape, etc. The average major axis length used herein represents a length of a longitudinal side of the particles derived from the shape of a primary particle thereof. In the case where the particles have a spherical shape, the average major axis length means a diameter. The average major axis length as required may be appropriately determined according to the aimed applications of the resulting particles.

The ferromagnetic iron nitride particles obtained in the process of Invention 2 may be coated with silica. The thickness of the silica coating layer is not more than 20 nm, and preferably not more than 17 nm.

Next, the process concerning Invention 5 is described.

First, the iron compound used in the process of Invention 5 is described.

Examples of the iron compound include, but are not particularly limited to, α-FeOOH, β-FeOOH, γ-FeOOH, α-Fe₂O₃, β-Fe₂O₃, Fe₂O₃, γ-Fe₂O₃, iron oxalate, iron acetate, iron nitrate, iron stearate and iron oleate. As the iron compound, there may be used different kinds of iron compounds, or there may be used two or more kinds of iron compounds. When two or more kinds of iron compounds are used, the proportion therebetween are not particularly limited. The shape of the iron compound is not particularly limited, and may be any of an acicular shape, a spindle shape, a rice grain shape, a spherical shape, a granular shape, a hexahedral shape, an octahedral shape, etc.

When using iron oxyhydroxide as the iron compound, the oxyhydroxide may be subjected to dehydration treatment, if required. The temperature of the dehydration treatment is preferably 80 to 350° C. When the temperature of the dehydration treatment is lower than 80° C., substantially no dehydration tends to proceed. When the temperature of the dehydration treatment is higher than 350° C., it may be difficult to obtain metallic iron particles at a low temperature in the subsequent reducing treatment. The temperature of the dehydration treatment is preferably 85 to 300° C.

The reducing agent used in the process of Invention 5 may be produced by mixing at least one compound selected from the group consisting of a metal hydride, a metal halide and a metal borohydride with the iron compound, and then subjecting the resulting mixture to heat treatment. Specific examples of the reducing agent include metal hydrides such as dimethyl aluminum hydride, diisobutyl aluminum hydride, calcium hydride, magnesium hydride, sodium hydride, potassium hydride, lithium hydride, titanium hydride and zirconium hydride; metal halides such as magnesium borohydride and sodium borohydride; and metal borohydrides such as isopropyl magnesium halide, gallium halide, indium halide, tin halide, zinc halide, cadmium halide, copper halide, nickel halide, manganese halide and sodium aluminum halide. These reducing agents may be used alone or in combination of any two or more thereof. When two or more reducing agent are used, the proportion therebetween is not particularly limited.

The reducing agent is suitably in the form of particles that are dry-mixed with the iron compound and the nitrogen-containing compound. It is preferred that the iron compound, the nitrogen-containing compound and the reducing agent are previously pulverized and mixed in a mortar, etc.

In addition, in particular, in the case where the reducing agent comprises water or a considerable amount of water is absorbed in the reducing agent, it is preferred that the reducing agent is previously subjected to drying or preheating treatment.

The mixing ratio between the iron compound and the reducing agent is not particularly limited, and the weight ratio of the reducing agent to the iron compound is 0.5 to 50, and preferably 0.8 to 30.

Examples of the nitrogen-containing compound used for obtaining the ferromagnetic iron nitride particles in the process of Invention 5 include, but are not particularly limited to, urea, ammonia water, ammonium chloride, nitric acid, methylamine, dimethylamine, ethylamine, piperazine, aniline, sodium amide, lithium diisopriopyl amide, potassium amide or the like, which may be used in the form of either a solid or a liquid. These nitrogen-containing compounds may be used alone or in combination of any two or more thereof. When using two or more kinds of nitrogen-containing compounds, the proportion therebetween is not particularly limited. Among these nitrogen-containing compounds, preferred are inorganic metal amide compounds and organic amine compounds, and especially preferred are inorganic metal amide compounds.

The mixing ratio between the iron compound and the nitrogen-containing compound is not particularly limited, and the weight ratio of the nitrogen-containing compound to the iron compound is 0.5 to 50, and preferably 0.8 to 30.

The purity of the reducing agent is not particularly limited, for example, is in the range of 50 to 99.9% and preferably 60 to 99% in view of a good balance between effectiveness and costs of the reducing agent.

The iron compound used for obtaining the ferromagnetic iron nitride particles in the process of Invention 5 may be coated with silica. The thickness of the silica coating layer is not more than 20 nm, and preferably not more than 17 nm.

The iron compound, the reducing agent and the nitrogen-containing compound are preferably weighed in atmospheric air or using a facility capable of controlling an atmosphere, a humidity and a temperature such as a glove box, and then pulverized and mixed in a mortar, etc.

The ferromagnetic iron nitride particles obtained according to the process of Invention 5 may be produced by subjecting the iron compound to reduction and nitridation at the same step, and then conducting the step of washing the resulting product.

The heat treatment of the iron compound, the reducing agent and the nitrogen-containing compound may be conducted by either a standing method or a flowing method, and is preferably performed in a sealed container. In a laboratory level, there may be used, for example, the method in which a mixture of the iron compound, the reducing agent and the nitrogen-containing compound is filled and sealed in a glass tube. Also, in a pilot scale, there may be used the method in which the mixture of the iron compound, the reducing agent and the nitrogen-containing compound is filled and sealed in a metal tube and subjected to heat treatment while flowing therein.

The temperature of the heat treatment of the mixture of the iron compound, the reducing agent and the nitrogen-containing compound is 50 to 280° C. The heat treatment temperature may be appropriately determined according to kind and amount of the reducing agent added, and a reducing temperature inherent to the respective iron compounds, and is preferably 80 to 275° C. and more preferably 100 to 250° C. When the heat treatment temperature is excessively high, different kinds of phases such as Fe₄N tend to be included in the resulting particles. Also, the heat treatment time is preferably 0.5 h to 7 days, and more preferably 1 h to 3 days.

The heat treatment may be conducted by appropriately selecting and using a continuous furnace, an RF high frequency furnace, etc.

The washing treatment is preferably carried out using dehydrated ethanol or methanol, though not particularly limited thereto. The amount of a washing solvent used for the washing treatment is not particularly limited, and the solvent may be used in an amount of not less than 100 mL per 1 g of the ferromagnetic iron nitride particles. The washing method is not particularly limited, and the washing treatment may be conducted by any method using a Nutsche, a press filter, a glass filter, a centrifugal separator or the like. The drying may be appropriately carried out by natural drying, vacuum drying, (vacuum) freeze drying, etc., or using an evaporator.

The ferromagnetic iron nitride particles obtained according to the process of Invention 5 has an average particle major axis length of 5 to 150 nm, and a main phase thereof is formed of ferromagnetic iron nitride. When the average particle major axis length of the ferromagnetic iron nitride particles is less than 5 nm, there tend to be present a large number of the atoms that are in contact with an interface between surfaces of the particles, so that it is not expected to obtain ferromagnetic iron nitride particles having a large magnetization. When the average particle major axis length of the ferromagnetic iron nitride particles is more than 150 nm, the nitridation tends to hardly proceed, so that the metallic iron, Fe₄N, etc., tend to be included in the obtained particles. The average particle major axis length of the ferromagnetic iron nitride particles is preferably 5 to 140 nm, and more preferably 6 to 135 nm.

The shape of the ferromagnetic iron nitride particles obtained according to the process of Invention 5 is not particularly limited, and may be any of an acicular shape, a spindle shape, a rice grain shape and a spherical shape. The average major axis length used herein represents a length of a longitudinal side of the particles derived from the shape of a primary particle thereof. In the case where the particles have a spherical shape, the average major axis length means a diameter. The average major axis length as required may be appropriately determined according to the aimed applications of the resulting particles.

Next, the ferromagnetic iron nitride particles obtained by the production process as described in Inventions 1, 2 and 5 are described.

The ferromagnetic iron nitride particles obtained by the production process as described in Inventions 1, 2 and 5 preferably comprise an Fe₁₆N₂ compound phase in an amount of not less than 80% as measured by Mössbauer spectrum data. In the Mössbauer spectrum, upon production of Fe₁₆N₂, a peak of an iron site having an internal magnetic field of not less than 330 kOe is observed. In particular, there is such a feature that the peak is observed in the vicinity of 395 kOe. In general, when the content of other phases than the above compound phase in the ferromagnetic particles is increased, the resulting particles tend to strongly exhibit properties as those of a soft magnet and therefore tend to be unsuitable as a material for a ferromagnetic hard magnet. However, the ferromagnetic iron nitride particles of the present invention can exhibit properties as a material for a ferromagnetic hard magnet to a sufficient extent.

The ferromagnetic iron nitride particles obtained by the production process as described in Inventions 1, 2 and 5 preferably respectively comprise a core formed of Fe₁₆N₂ and an outer shell in which FeO is present to thereby form a simple structure of Fe₁₆N₂/FeO from the core towards the outer shell. The Fe₁₆N and FeO are preferably topotactically bonded to each other to form a crystallographically continuous structure. The oxide film of the outer shell may comprise Fe₃O₄, Fe₂O₃ or α-Fe. When the Fe₁₆N₂ particles have a low purity, these impurities may be contained in the resulting particles. However, the high-purity particles have an outer shell comprising FeO only. The thickness of the FeO film of the outer shell is not more than 5 nm and preferably not more than 4 nm. With the increase in purity of Fe₁₆N₂ in the particles, the thickness of the FeO film tends to be reduced. The thickness of the FeO film is not particularly limited, and is preferably as small as possible because a volume fraction of Fe₁₆N₂ in the particles is improved. The lower limit of the thickness of the FeO film is not particularly limited, and is about 0.5 nm.

The volume fraction of FeO on the surface of the respective ferromagnetic iron nitride particles obtained by the production process as described in Inventions 1, 2 and 5 is controlled such that the ratio of the volume of FeO to a whole volume of the particles is preferably not more than 25%. When the purity of Fe₁₆N₂ in the particles is increased, the volume fraction of FeO therein is reduced. The volume fraction of FeO in the respective ferromagnetic iron nitride particles is more preferably not more than 23% and still more preferably 3 to 20%.

The ferromagnetic iron nitride particles obtained by the production process as described in Inventions 1, 2 and 5 preferably have a coercive force Hₒ of not less than 1.5 kOe and a saturation magnetization σₛ of not less than 150 emu/g as measured at 5 K. The definition “ferromagnetic” means that it satisfies at least these magnetic properties. When the saturation magnetization σₛ and the coercive force H, of the ferromagnetic iron nitride particles are respectively out of the above-specified ranges, the resulting ferromagnetic iron nitride particles may fail to exhibit sufficient magnetic properties required for a hard magnetic material. More preferably, the coercive force Hₒ of the ferromagnetic iron nitride particles is not less than 1.6 kOe, and the saturation magnetization a, of the ferromagnetic iron nitride particles is not less than 180 emu/g.

The ferromagnetic iron nitride particles obtained by the production process as described in Inventions 1, 2 and 5 preferably have a nitridation rate of 8 to 13 mol % as determined from a lattice constant thereof. An optimum nitridation rate of the ferromagnetic iron nitride particles as determined from a chemical composition of Fe₁₆N₂ is 11.1 mol %. The nitridation rate of the ferromagnetic iron nitride particles is more preferably 8.5 to 12.5 mol % and still more preferably 9.0 to 12 mol %.

The ferromagnetic iron nitride particles obtained by the production process as described in Inventions 1, 2 and 5 preferably have a BET specific surface area of 5.0 to 40 m²/g. When the BET specific surface area of the ferromagnetic iron nitride particles is less than 5 m²/g, the nitridation rate of the ferromagnetic iron nitride particles tends to be lowered, so that the production rate of Fe₁₆N₂ therein tends to be decreased, and it may be difficult to obtain ferromagnetic iron nitride particles having desired coercive force and saturation magnetization. When the BET specific surface area of the ferromagnetic iron nitride particles is more than 40 m²/g, it may be difficult to obtain ferromagnetic iron nitride particles having a desired saturation magnetization value. The BET specific surface area of the ferromagnetic iron nitride particles is more preferably 5.5 to 38 m²/g and still more preferably 6.0 to 35 m²/g.

Next, the anisotropic magnet comprising the ferromagnetic iron nitride particles obtained by the process of Invention 2 and the process of Invention 5 is described.

The magnetic properties of the anisotropic magnet according to the present invention may be controlled so as to attain desired magnetic properties (such as a coercive force, a residual magnetic flux density and a maximum energy product) according to the purposes and applications as aimed.

The magnetic orientation method of the magnet is not particularly limited. For example, the ferromagnetic iron nitride particles comprising an Fe₁₆N₂ compound phase in an amount of not less than 80% as measured by Mössbauer spectrum may be mixed and kneaded together with a dispersant, etc., in an EVA resin (ethylene-vinyl acetate copolymer) at a temperature not lower than a glass transition temperature thereof and then molded, and a desired external magnetic field may be applied to the resulting molded product at a temperature nearly exceeding the glass transition temperature to accelerate a magnetic orientation of the molded product. Alternatively, a resin such as a urethane resin, an organic solvent and the above ferromagnetic iron nitride particles may be strongly mixed with each other using a paint shaker, etc., and pulverized to prepare an ink, and the resulting ink may be applied and printed on a resin film with a blade or by a roll-to-roll method, and rapidly passed through a magnetic field to magnetically orient the resulting coated film. In addition, the magnetic orientation may be conducted by RIP (resin isostatic pressing) method in order to attain a still higher density and maximize a crystal magnetic anisotropy. The ferromagnetic iron nitride particles may be previously provided on a surface thereof with an insulation coating film of silica, alumina, zirconia, tin oxide, antimony oxide or the like. The method of forming the insulation coating film is not particularly limited, and there may be used a method of adsorbing the insulating material on the surface of the respective particles by controlling a surface potential of the respective particles in a solution of the material, a vapor deposition method such as CVD, etc.

Next, a resin composition for the bonded magnet comprising the ferromagnetic iron nitride particles obtained by the process of Invention 2 and the process of Invention 5 is described.

The resin composition for the bonded magnet according to the present invention may be prepared by dispersing the ferromagnetic iron nitride particles according to the present invention in a binder resin. The resin composition for the bonded magnet comprises 85 to 99% by weight of the ferromagnetic iron nitride particles and the balance comprising the binder resin and other additives.

The ferromagnetic iron nitride particles may be previously provided on a surface thereof with an insulation coating film of silica, alumina, zirconia, tin oxide, antimony oxide or the like. The method of forming the insulation coating film is not particularly limited, and there may be used a method of adsorbing the insulating material on the surface of the respective particles by controlling a surface potential of the respective particles in a solution of the material, a vapor deposition method such as CVD, etc.

The binder resin used in the resin composition for the bonded magnet may be selected from various resins depending upon the molding method used. In the case of an injection molding method, an extrusion molding method and a calender molding method, thermoplastic resins may be used as the binder resin. In the case of a compression molding method, thermosetting resins may be used as the binder resin. Examples of the thermoplastic resins used in the present invention include nylon (PA)-based resins, polypropylene (PP)-based resins, ethylene-vinyl acetate (EVA)-based resins, polyphenylene sulfide (PPS)-based resins, liquid crystal plastic (LCP)-based resins, elastomer-based resins and rubber-based resins. Examples of the thermosetting resins used in the present invention include epoxy-based resins and phenol-based resins.

Meanwhile, upon production of the resin composition for the bonded magnet, in order to facilitate molding of the composition and attain sufficient magnetic properties, in addition to the binder resin, there may also be used various known additives such as a plasticizer, a lubricant and a coupling agent, if required. Further, various other kinds of magnet particles such as ferrite magnet particles may also be mixed in the resin composition.

These additives may be adequately selected according to the aimed applications. As the plasticizer, commercially available products may be appropriately used according to the resins used. The total amount of the plasticizers added is about 0.01 to about 5.0% by weight based on the weight of the binder resin.

Examples of the lubricant used in the present invention include stearic acid and derivatives thereof, inorganic lubricants, oil-based lubricants. The lubricant may be used in an amount of about 0.01 to about 1.0% by weight based on a whole weight of the bonded magnet.

As the coupling agent, commercially available products may be used according to the resins and fillers used. The coupling agent may be used in an amount of about 0.01 to about 3.0% by weight based on the weight of the binder resin used.

The resin composition for the bonded magnet according to the present invention may be produced by mixing and kneading the ferromagnetic iron nitride particles with the binder resin.

The mixing of the ferromagnetic iron nitride particles with the binder resin may be carried out using a mixing device such as a Henschel mixer, a V-shaped mixer and a Nauta mixer, whereas the kneading may be carried out using a single-screw kneader, a twin-screw kneader, a mill-type kneader, an extrusion kneader or the like.

Next, the bonded magnet according to the present invention is described.

The magnetic properties of the bonded magnet may be controlled so as to attain desired magnetic properties (such as a coercive force, a residual magnetic flux density and a maximum energy product) according to the aimed applications.

The bonded magnet according to the present invention may be produced by subjecting the above resin composition for the bonded magnet to a molding process by a known molding method such as an injection molding method, an extrusion molding method, a compression molding method or a calender molding method, and then subjecting the resulting molded product to electromagnet magnetization or pulse magnetization by an ordinary method to form the bonded magnet.

Next, the sintered magnet according to the present invention is described.

The sintered magnet according to the present invention may be produced by subjecting the ferromagnetic iron nitride particles to compression molding process and heat treatment. The magnetic field applied and the conditions of the compression molding process are not particularly limited, and may be adjusted according to those values required for the resulting compacted magnet. For example, the magnetic field may be adjusted to the range of 1 to 15 T, and the pressure upon the compression molding process may be adjusted to the range of 1.5 to 15 ton/cm². The molding machine used is not particularly limited, and there may be used CIP or RIP. The shape or size of the resulting molded product may be appropriately determined according to the applications thereof.

The ferromagnetic iron nitride particles may be previously provided on a surface thereof with an insulation coating film of silica, alumina, zirconia, tin oxide, antimony oxide or the like. The method of forming the insulation coating film is not particularly limited, and there may be used a method of adsorbing the insulating material on the surface of the respective particles by controlling a surface potential of the respective particles in a solution of the material, a vapor deposition method such as CVD, etc.

Examples of the lubricant used in the sintered magnet of the present invention include stearic acid and derivatives thereof, inorganic lubricants, oil-based lubricants. The lubricant may be used in an amount of about 0.01 to about 1.0% by weight based on a whole weight of the bonded magnet.

Examples of the binder resin used in the sintered magnet of the present invention include polyolefins such as polyethylene and polypropylene; thermoplastic resins such as polyvinyl alcohol, polyethyleneoxide, PPS, liquid crystal polymers, PEEK, polyimides, polyether imides, polyacetals, polyether sulfones, polysulfones, polycarbonates, polyethylene terephthalate, polybutylene terephthalate, polyphenylene oxide, polyphthalamide and polyamides; and mixtures thereof. The binder resin may be used in an amount of about 0.01 to about 5.0% by weight based on a whole weight of the bonded magnet.

The heat treatment may be conducted by appropriately selecting and using a continuous furnace, an RF high frequency furnace, etc. The heat treatment conditions are not particularly limited.

Next, the compacted magnet according to the present invention is described.

The compacted magnet according to the present invention may be produced by subjecting the resulting ferromagnetic iron nitride particles to compression molding process in a magnetic field. The magnetic field applied and the conditions of the compression molding process are not particularly limited, and may be adjusted according to those values required for the resulting compacted magnet. For example, the magnetic field may be adjusted to the range of 1.0 to 15 T, and the pressure upon the compression molding process may be adjusted to the range of 1.5 to 15 ton/cm². The molding machine used is not particularly limited, and there may be used CIP or RIP. The shape or size of the resulting molded product may be appropriately determined according to the applications thereof.

The ferromagnetic iron nitride particles may be previously provided on a surface thereof with an insulation coating film of silica, alumina, zirconia, tin oxide, antimony oxide or the like. The method of forming the insulation coating film is not particularly limited, and there may be used a method of adsorbing the insulating material on the surface of the respective particles by controlling a surface potential of the respective particles in a solution of the material, a vapor deposition method such as CVD, etc.

Examples of the lubricant used in the compacted magnet of the present invention include stearic acid and derivatives thereof, inorganic lubricants, oil-based lubricants. The lubricant may be used in an amount of about 0.01 to about 1.0% by weight based on a whole weight of the bonded magnet.

Examples of the binder resin used in the compacted magnet of the present invention include polyolefins such as polyethylene and polypropylene; thermoplastic resins such as polyvinyl alcohol, polyethyleneoxide, PPS, liquid crystal polymers, PEEK, polyimides, polyether imides, polyacetals, polyether sulfones, polysulfones, polycarbonates, polyethylene terephthalate, polybutylene terephthalate, polyphenylene oxide, polyphthalamide and polyamides; and mixtures thereof. The binder resin may be used in an amount of about 0.01 to about 5.0% by weight based on a whole weight of the bonded magnet.

The heat treatment may be conducted by appropriately selecting and using a continuous furnace, an RF high frequency furnace, etc. The heat treatment conditions are not particularly limited.

### EXAMPLES

The present invention is described in more detail below by the following Examples. However, these Examples are only illustrative and not intended to limit the invention thereto. In the following, Examples 1-1 to 1-3 and Comparative Example 1-1 are examples relating to magnets produced using the ferromagnetic iron nitride particles obtained by the process as described in Inventions 1 to 4, and Examples 2-1 to 2-5 and Comparative Example 2-1 are examples relating to magnets produced using the ferromagnetic iron nitride particles obtained by the process as described in Inventions 1 and 5 to 8. The evaluation methods used in the following Examples and Comparative Examples are explained below.

The specific surface area value of the specimen was measured by a B.E.T. method based on nitrogen absorption.

The particle sizes of the iron compound, the metallic iron and the ferromagnetic iron nitride particles were measured using a transmission electron microscope “JEM-1200EXII” manufactured by Nippon Denshi Co., Ltd. In this case, particle sizes of 120 particles randomized were measured to obtain an average value thereof.

The constituting phases of the starting material and the resulting ferromagnetic iron nitride particles were determined by identification using a powder X-ray diffractometer (XRD; “D8 ADVANCE” manufactured by BRUKER CORP.) and by electron diffraction (ED) using a transmission electron microscope “JEM-2000EX” manufactured by Nippon Denshi Co., Ltd., and an ultra-high resolution spectroscopic electron microscope (HREM) “HF-2000”manufactured by Hitachi High-Technologies Corp. Upon measuring the XRD, the specimen prepared by mixing the ferromagnetic iron nitride particles with silicone grease in a glove box was subjected to XRD.

The magnetic properties of the obtained ferromagnetic iron nitride particles were measured at room temperature (300 K) in a magnetic field of 0 to 9 T using a physical property measurement system (PPMS+VSM) manufactured by Quantum Design Japan Co., Ltd. Separately, the temperature dependency of a magnetic susceptibility of the ferromagnetic iron nitride particles in a temperature range of from 5 K to 300 K was also evaluated.

### Example 1-1

### Preparation of Metallic Iron

Oleylamine (weight ratio to metallic iron: 10 times) held at 180° C. was added to 50 mL of a kerosine solvent while stirring with a stirrer, and an iron pentacarbonyl gas was introduced thereinto at a flow rate of 30 mL/min for 10 min, and then the resulting mixture was allowed to stand for 1 hr, thereby obtaining spherical metallic iron particles having an average particle major axis length (=diameter) of 9.7 nm. The resulting spherical metallic iron particles were subjected to centrifugal separation in a glove box, and then washed with methanol, thereby obtaining a metallic iron paste.

<Coating with Silica>

Next, the thus obtained paste in an amount corresponding to 15 mg of metallic iron as a solid content, and 3.65 g of “Igepal CO-520” (reagent) were added to a mixed solvent comprising 48.75 g of dehydrated cyclohexane (reagent) and 0.4 g of TEOS (tetraethoxysilane; reagent), and the resulting reaction solution was intimately mixed. Successively, 0.525 mL of a 28 wt. % ammonia water (reagent) was added to the solution, and the obtained mixture was stirred at room temperature (25° C.) for 28 hr using a stirrer. Thereafter, the mixture was subjected to centrifugal separation in a glove box, and then washed with methanol. As a result of XRD, the obtained specimen was metallic iron, and the thickness of a silica coating layer formed thereon was 13 nm.

### <Preparation of Ferromagnetic Iron Nitride Particles>

In a glove box, 0.8 g of the above obtained silica-coated metallic iron particles, 2.5 g of ammonium chloride and 2.5 g of sodium amide were lightly mixed in an agate mortar, and the resulting mixture was filled and sealed under vacuum in a glass tube. Successively, the glass tube was placed in an electric furnace to subject contents thereof to heat treatment at 130° C. for 48 hr. The thus heat-treated product was quenched, and the glass tube was taken out from the furnace. The glass tube was placed again in a glove box, and the specimen was taken out from the glass tube, and then fully washed with methanol and treated using a centrifugal separator, thereby removing impurities therefrom.

### <Analysis and Evaluation of Resulting Specimen>

As a result of XRD, it was confirmed that the resulting specimen was constituted of a ferromagnetic iron nitride Fe₁₆N₂ single phase. Also, it was confirmed that the obtained ferromagnetic iron nitride particles had an average particle major axis length (=diameter) of 9.7 nm, and the thickness of the silica coating layer formed thereon was 13 nm. Further, it was confirmed that the ferromagnetic iron nitride moiety of the particles had a saturation magnetization of 214 emu/g as measured at 5 K in a magnetic field of 14.5 kOe.

### Example 1-2

While flowing an argon gas through a four-necked separable flask at a flow rate of 500 mL/min, 0.25 L of ethylene glycol, 7.2 g of granular sodium hydroxide, 0.67 g of oleylamine, 6.39 g of iron acetyl acetonate and 0.15 g of platinum acetyl acetonate were charged into the flask, and heated to 125° C. while stirring. After allowed to stand for 1 hr, the contents of the flask were further heated to 185° C. and held at that temperature for 2.5 hr. Thereafter, the reaction solution was cooled to room temperature. The thus reacted specimen was transferred into a separating funnel filled with 250 mL of dehydrated hexane. At this time, the specimen was sufficiently shaken while applying an ultrasonic wave thereto from outside such that the produced nanoparticles were transferred from ethylene glycol to the hexane solvent. The hexane to which the nanoparticles were transferred was placed in a beaker and naturally dried in a draft chamber. As a result, it was confirmed that the resulting nanoparticles were formed of γ-Fe₂O, and almost spherical particles having an average particle major axis length of 16 nm.

Next, 5 g of the thus obtained γ-Fe₂O₃ and 85 g of calcium hydride (reagent) were lightly mixed with each other, and then the resulting mixture was placed in a stainless steel container capable of vacuum drawing and underwent vacuum evacuation. The obtained product was subjected to heat treatment in an electric furnace at 200° C. for 25 hr and then transferred into a glove box. Further, the resulting product was fully washed with methanol to remove impurities therefrom and then dried, thereby obtaining metallic iron particles.

In a glove box, 0.8 g of the thus obtained metallic iron particles, 3.5 g of ammonium chloride, 1.0 g of sodium amide and 0.5 g of urea were lightly mixed with each other in an agate mortar, and the resulting mixture was filled and sealed under vacuum in a glass tube. Successively, the glass tube was placed in an electric furnace to subject contents thereof to heat treatment at 135° C. for 30 hr. The thus heat-treated product was quenched, and the glass tube was taken out from the furnace. The glass tube was placed again in a glove box, and the specimen was taken out from the glass tube, and then fully washed with methanol and treated using a centrifugal separator, thereby removing impurities therefrom.

As a result of XRD, it was confirmed that the resulting specimen was constituted of a ferromagnetic iron nitride Fe₁₆N₂ single phase. Also, it was confirmed that the obtained ferromagnetic iron nitride particles had an average particle major axis length (=diameter) of 13 nm. Further, it was confirmed that the ferromagnetic iron nitride particles had a saturation magnetization of 206 emu/g as measured at 5 K in a magnetic field of 14.5 kOe.

### Example 1-3

Ferric chloride hexahydrate was weighed and sampled in an amount of 27.05 g in a beaker, and pure water was added to the beaker to prepare 500 mL of a solution. Added to the resulting solution was 2.12 g of urea, and the resulting mixture was stirred at room temperature for 30 min. Next, the resulting reaction solution was transferred into a closed system pressure container, and reacted therein at 85° C. for 3.5 hr while stirring with an agitation blade at 200 rpm. The obtained specimen was separated by filtration using a Nutsche, and sufficiently washed with pure water in an amount of 30 mL per 1 g of the specimen. The resulting specimen was acicular akaganeite having an average particle major axis length of 130 nm. The resulting specimen was dried at 40° C. overnight, and reduced in a hydrogen gas flow at 282° C. for 2 hr, and taken out in a glove box. The resulting specimen was an α-Fe single phase having an average major axis length of 123 nm.

In a glove box, 2 g of the thus obtained metallic iron particles, 5.0 g of ammonium chloride and 1.0 g of sodium amide were lightly mixed with each other, and the resulting mixture was filled and sealed under vacuum in a glass tube. Successively, the glass tube was placed in an electric furnace to subject contents thereof to heat treatment at 145° C. for 18 hr. The thus heat-treated product was quenched, and the glass tube was taken out from the furnace. The glass tube was placed again in a glove box, and the specimen was taken out from the glass tube, and then fully washed with methanol and treated using a centrifugal separator to thereby remove impurities therefrom.

As a result of XRD, it was confirmed that the resulting specimen was constituted of a ferromagnetic iron nitride Fe₁₆N₂ single phase. Also, it was confirmed that the obtained ferromagnetic iron nitride particles had an average particle major axis length of 123 nm. Further, it was confirmed that the ferromagnetic iron nitride particles had a saturation magnetization of 218 emu/g as measured at 5 K in a magnetic field of 14.5 kOe.

### Comparative Example 1-1

The temperature of an aqueous solution prepared by dissolving 180 g of ferrous chloride tetrahydrate in 2 L of pure water was adjusted to 22° C. While flowing air through the aqueous solution at a rate of 10 L/min, after 10 min, 209 mL of an aqueous solution in which 11.16 g of sodium hydroxide was dissolved, was slowly added thereto over 20 min to adjust a pH value thereof to 7.0. After 1 hr, 100 mL of the reaction solution whose pH value was reduced to 6.7 was transferred into a 300 mL glass beaker, and reacted for 24 hr at room temperature while rotating a stirrer at 300 rpm. The resulting particles were separated by filtration using a Nutsche, and sufficiently washed with pure water in an amount of 200 mL per 5 g of the specimen.

The resulting specimen was acicular lepidocrocite particles having an average particle major axis length of 2700 nm, an aspect ratio of 45.0 and a specific surface area of 83.2 m²/g. The thus obtained particles were dried at 120° C. overnight, and successively subjected to heat treatment at 350° C. for 1 hr. The thus treated particles were pulverized in an attritor with an agate mortar for 1 hr. Further, only the aggregated particles having a particle size of not more than 180 μm were extracted using a vibrating sieve.

Successively, the obtained particles were subjected to reducing treatment at 260° C. for 3 hr in a hydrogen gas flow. Further, the obtained particles were subjected to nitridation treatment at 148° C. for 9 hr while flowing a mixed gas comprising a nitrogen gas and a hydrogen gas at a mixing ratio of 3:1 at a total flow rate of 10 L/min. Thereafter, an argon gas was flowed through the reaction system to drop an inside temperature thereof to room temperature at which feed of the argon gas was stopped and the atmosphere was replaced with nitrogen over 3 hr. Next, the resulting specimen was taken out in a glove box directly connected to the reactor.

As a result of XRD, it was confirmed that the thus obtained particles were formed of α-Fe metal only, and no production of ferromagnetic iron nitride was recognized.

### Example 2-1

### Preparation of Metallic Iron Particles

A colorless transparent glass three-necked separable flask (100 mL) equipped with an air-cooling type reflux tube and a thermometer was charged with 25 mL of dioctyl ether (reagent produced by Aldrich) and 8 mmol of oleylamine (reagent produced by Aldrich). The dioctyl ether and oleylamine used above were previously subjected to vacuum drawing using a rotary pump in a temperature range of from room temperature to 50° C. for 1 hr.

Separately, 2 mmol of iron pentacarbonyl (reagent produced by Kanto Kagaku Co., Inc.) was dissolved in 2 mL of a solution (dioctyl ether+oleylamine) as a part of the solution in the flask to prepare a raw material solution. The solution in the flask was heated to 200° C. while bubbling an argon gas therein using a mantle heater, and the above prepared raw material solution was rapidly injected thereinto using a syringe. Immediately after injecting the raw material solution into the flask, it was confirmed that spherical metallic iron particles having a particle diameter of 5 nm were produced. After injecting the raw material solution, the obtained reaction solution in the flask was further heated and refluxed for 30 min (temperature of the reaction solution: 289° C.), and then the heart source was removed to allow the reaction solution to stand for cooling to room temperature. The resulting reaction solution was subjected to bubbling with a mixed gas comprising oxygen and argon at a mixing ratio of 0.56:99.5 vol % for 1 h, thereby oxidizing a 0.8 nm-thick surface portion of the respective metallic iron particles.

Into the reaction product solution (10 mL) comprising the obtained specimen particles was added 30 mL of dehydrated ethanol (reagent produced by Wako Pure Chemical Industries, Ltd.) to precipitate black insoluble components therein. The obtained reaction mixture was then subjected to centrifugal separation, and further the resulting supernatant liquid was removed by decantation.

Meanwhile, the above procedures all were carried out in a glove box having an argon atmosphere comprising oxygen and water each being present in an amount of not more than 10 ppm.

<Coating with Silica>

Then, 90 mg of the resulting specimen particles, as well as 3.65 g of “Igepal CO-520” (produced by Aldrich), 48.75 g of cyclohexane (reagent produced by Wako Pure Chemical Industries, Ltd.), 0.38 mL of a 28 wt. % ammonia water (reagent produced by Wako Pure Chemical Industries, Ltd.) and 0.4 g of tetraethoxysilane (reagent produced by Nacalai Tesque) were respectively weighed. Then, a flour-necked separable flask was first charged with cyclohexane and then with the 5 nm-size specimen particles, and further with “Igepal CO-520”, and stirring of the contents of the flask was initiated using a fluororesin agitation blade at a rotating speed of 160 rpm, and continued for 0.5 hr while maintaining the reaction system at room temperature. Next, tetraethoxysilane and then 28% ammonia water were successively added to the flask, and the contents of the flask were held while stirring for 18 h.

The resulting specimen was in the form of iron compound particles having an average particle major axis length (=diameter) of 5 nm which were respectively uniformly coated with a 6 nm-thick silica coating layer.

### <Preparation of Ferromagnetic Iron Nitride Particles>

The thus obtained silica-coated iron compound particles were separated using a centrifugal separator, dried in an evaporator and taken out in air. In a glove box, 0.8 g of the thus obtained particles, 2.5 g of ammonium chloride (reagent produced by Wako Pure Chemical Industries, Ltd.) and 2.5 g of sodium amide (reagent produced by Nacalai Tesque) were lightly mixed with each other in an agate mortar, and the resulting mixture was filled and sealed under vacuum in a glass tube. Successively, the glass tube was placed in an electric furnace to subject contents thereof to heat treatment at 130° C. for 48 h. The thus heat-treated product was quenched, and the glass tube was taken out from the furnace. The glass tube was placed again in a glove box, and the specimen was taken out from the glass tube, and then fully washed with methanol and treated using a centrifugal separator, thereby removing impurities therefrom.

### <Analysis and Evaluation of Resulting Specimen>

As a result of XRD, it was confirmed that the resulting specimen was constituted of a ferromagnetic iron nitride Fe₁₆N₂ single phase. Also, it was confirmed that the obtained ferromagnetic iron nitride particles had an average particle major axis length (=diameter) of 4 nm, and the thickness of the silica coating layer formed thereon was 6 nm. Further, it was confirmed that the ferromagnetic iron nitride moiety of the particles had a saturation magnetization of 216 emu/g as measured at 5 K in a magnetic field of 14.5 kOe.

### Example 2-2

### Preparation of Metallic Iron

Oleylamine (weight ratio to metallic iron: 10 times) held at 180° C. was added to 50 mL of a kerosine solvent while stirring with a stirrer, and an iron pentacarbonyl gas was introduced thereinto at a flow rate of 30 mL/min for 10 min, and then the resulting mixture was allowed to stand for 1 hr, thereby obtaining spherical metallic iron particles having an average particle major axis length (=diameter) of 9.7 nm. The resulting spherical metallic iron particles were subjected to centrifugal separation in a glove box, and then washed with methanol, thereby obtaining a metallic iron paste.

<Coating with Silica>

Next, the thus obtained paste in an amount corresponding to 15 mg of metallic iron as a solid content, and 3.65 g of “Igepal CO-520” (reagent produced by Aldrich) were added to a mixed solvent comprising 48.75 g of dehydrated cyclohexane (reagent produced by Wako Pure Chemical Industries, Ltd.) and 0.4 g of tetraethoxysilane (reagent produced by Wako Pure Chemical Industries, Ltd.), and the resulting reaction solution was intimately mixed. Successively, 0.525 mL of a 28 wt. % ammonia water (reagent produced by Wako Pure Chemical Industries, Ltd.) was added to the solution, and the obtained mixture was stirred at room temperature for 28 hr using a stirrer. Thereafter, the mixture was subjected to centrifugal separation in air, and then washed with methanol. As a result, it was confirmed that the obtained specimen was γ-Fe₂O₃ having an average particle major axis length (=diameter) of 9.7 nm, and the thickness of a silica coating layer formed thereon was 13 nm.

### <Preparation of Ferromagnetic Iron Nitride Particles>

In a glove box, 0.8 g of the above obtained particles, 2.5 g of ammonium chloride (reagent produced by Wako Pure Chemical Industries, Ltd.) and 2.5 g of sodium amide (reagent produced by Nacalai Tesque) were lightly mixed with each other in an agate mortar, and the resulting mixture was filled and sealed under vacuum in a glass tube. Successively, the glass tube was placed in an electric furnace to subject contents thereof to heat treatment at 130° C. for 48 hr. The thus heat-treated product was quenched, and the glass tube was taken out from the furnace. The glass tube was placed again in a glove box, and the specimen was taken out from the glass tube, and then fully washed with methanol and treated using a centrifugal separator, thereby removing impurities therefrom.

### <Analysis and Evaluation of Resulting Specimen>

As a result of XRD, it was confirmed that the resulting specimen was constituted of a ferromagnetic iron nitride Fe₁₆N₂ single phase. Also, it was confirmed that the obtained ferromagnetic iron nitride particles had an average particle major axis length (=diameter) of 8.4 nm, and the thickness of the silica coating layer formed thereon was 13 nm. Further, it was confirmed that the ferromagnetic iron nitride moiety of the particles had a saturation magnetization of 221 emu/g as measured at 5 K in a magnetic field of 14.5 kOe.

### Example 2-3

### Preparation of Metallic Iron

While flowing an argon gas through a four-necked separable flask at a flow rate of 500 mL/min, 0.25 L of ethylene glycol (reagent produced by Wako Pure Chemical Industries, Ltd.), 7.2 g of granular sodium hydroxide (reagent produced by Nacalai Tesque), 0.67 g of oleylamine (reagent produced by Wako Pure Chemical Industries, Ltd.), 6.39 g of iron acetyl acetonate (reagent produced by Aldrich) and 0.15 g of platinum acetyl acetonate (reagent produced by Wako Pure Chemical Industries, Ltd.) were charged into the flask, and heated to 125° C. while stirring. After allowed to stand for 1 hr, the contents of the flask were further heated to 185° C. and held at that temperature for 2.5 hr. Thereafter, the reaction solution was cooled to room temperature. The thus reacted specimen was transferred into a separating funnel filled with 250 mL of dehydrated hexane (reagent produced by Wako Pure Chemical Industries, Ltd.). At this time, the specimen was sufficiently shaken while applying an ultrasonic wave thereto from outside such that the produced nanoparticles were transferred from ethylene glycol to the hexane solvent. The hexane to which the nanoparticles were transferred was placed in a 50 mL beaker and naturally dried in a draft chamber. As a result, it was confirmed that the resulting nanoparticles were formed of γ-Fe₂O₃ and almost spherical particles having an average particle major axis length (=diameter) of 16 nm.

### <Preparation of Ferromagnetic Iron Nitride Particles>

Next, 0.5 g of the thus obtained γ-Fe₂03 and 8.5 g of calcium hydride (reagent produced by Wako Pure Chemical Industries, Ltd.) were lightly mixed with each other. Further, in a glove box, the resulting mixture was lightly mixed in an agate mortar with 3 g of ammonium chloride (reagent produced by Wako Pure Chemical Industries, Ltd.), 0.3 g of sodium amide (reagent produced by Nacalai Tesque) and 0.1 g of urea (reagent produced by Wako Pure Chemical Industries, Ltd.), and the resulting mixture was filled and sealed under vacuum in a glass tube. Successively, the glass tube was placed in an electric furnace to subject contents thereof to heat treatment at 128° C. for 40 hr. The thus heat-treated product was quenched, and the glass tube was taken out from the furnace. The glass tube was placed again in a glove box, and the specimen was taken out from the glass tube, and then fully washed with methanol and treated using a centrifugal separator, thereby removing impurities therefrom.

### <Analysis and Evaluation of Resulting Specimen>

As a result of XRD, it was confirmed that the resulting specimen was constituted of a ferromagnetic iron nitride Fe₁₆N₂ single phase. Also, it was confirmed that the obtained ferromagnetic iron nitride particles had an average particle major axis length (=diameter) of 13 nm. Further, it was confirmed that the ferromagnetic iron nitride particles had a saturation magnetization of 206 emu/g as measured at 5 K in a magnetic field of 14.5 kOe.

### Example 2-4

Ferric chloride hexahydrate (reagent produced by Wako Pure Chemical Industries, Ltd.) was weighed and sampled in an amount of 27.05 g in a beaker, and pure water was added to the beaker to prepare 500 mL of a solution. Added to the resulting solution was 2.12 g of urea, and the resulting mixture was stirred at room temperature for 30 min. Next, the resulting reaction solution was transferred into a closed system pressure container, and reacted therein at 85° C. for 3.5 hr while stirring with an agitation blade at 200 rpm. The obtained specimen was separated by filtration using a Nutsche, and sufficiently washed with pure water in an amount of 30 mL per 1 g of the specimen. The resulting specimen was acicular akaganeite having an average particle major axis length of 130 nm.

In a glove box, 2 g of the thus obtained iron compound particles, 5.0 g of ammonium chloride (reagent produced by Wako Pure Chemical Industries, Ltd.) and 1.5 g of sodium amide (reagent produced by Nacalai Tesque) were lightly mixed with each other, and the resulting mixture was filled and sealed under vacuum in a glass tube. Successively, the glass tube was placed in an electric furnace to subject contents thereof to heat treatment at 145° C. for 18 hr. The thus heat-treated product was quenched, and the glass tube was taken out from the furnace. The glass tube was placed again in a glove box, and the specimen was taken out from the glass tube, and then fully washed with methanol and treated using a centrifugal separator to thereby remove impurities therefrom.

As a result of XRD, it was confirmed that the resulting specimen was constituted of a ferromagnetic iron nitride Fe₁₆N₂ single phase. Also, it was confirmed that the obtained ferromagnetic iron nitride particles had an average particle major axis length of 118 nm. Further, it was confirmed that the ferromagnetic iron nitride particles had a saturation magnetization of 218 emu/g as measured at 5 K in a magnetic field of 14.5 kOe.

### Example 2-5

In a glove box, 25 mg of iron (II) acetate (reagent produced by Wako Pure Chemical Industries, Ltd.), 25 mg of sodium hydride (reagent produced by Wako Pure Chemical Industries, Ltd.), 75 mg of ammonium chloride (reagent produced by Wako Pure Chemical Industries, Ltd.) and 75 mg of sodium amide (reagent produced by Nacalai Tesque) were intimately mixed with each other, and the resulting mixture was filled and sealed under vacuum in a glass tube. Successively, the glass tube was placed in an electric furnace to subject contents thereof to heat treatment at 125° C. for 20 hr. The thus heat-treated product was quenched, and the glass tube was taken out from the furnace. The glass tube was placed again in a glove box, and the specimen was taken out from the glass tube, and then fully washed with methanol and treated using a centrifugal separator to thereby remove impurities therefrom.

As a result of XRD, it was confirmed that the resulting specimen was constituted of a ferromagnetic iron nitride Fe₁₆N₂ main phase and a slight amount of α-Fe. Also, it was confirmed that the obtained ferromagnetic iron nitride particles had an average particle major axis length of 12 nm. Further, it was confirmed that the ferromagnetic iron nitride particles had a saturation magnetization of 196 emu/g as measured at 5 K in a magnetic field of 14.5 kOe.

### Comparative Example 2-1

The temperature of an aqueous solution prepared by dissolving 180 g of ferrous chloride tetrahydrate in 2 L of pure water was adjusted to 22° C. While flowing air through the aqueous solution at a flow rate of 10 L/min, after 10 min, 209 mL of an aqueous solution in which 11.16 g of sodium hydroxide was dissolved, was slowly added thereto over 20 min to adjust a pH value thereof to 7.0. After 1 hr, 100 mL of the reaction solution whose pH value was reduced to 6.7 was transferred into a 300 mL glass beaker, and reacted for 24 hr at room temperature while rotating a stirrer at 300 rpm. The resulting particles were separated by filtration using a Nutsche, and sufficiently washed with pure water in an amount of 200 mL per 5 g of the specimen.

The resulting specimen was acicular lepidocrocite particles having an average particle major axis length of 2700 nm, an aspect ratio of 45.0 and a specific surface area of 83.2 m²/g. The thus obtained particles were dried at 120° C. overnight, and successively subjected to heat treatment at 350° C. for 1 hr. The thus treated particles were pulverized in an attritor with an agate mortar for 1 hr. Further, only the aggregated particles having a particle diameter of not more than 180 μm were extracted using a vibrating sieve.

Successively, the obtained particles were subjected to reducing treatment at 260° C. for 3 hr in a hydrogen gas flow. Further, the obtained particles were subjected to nitridation treatment at 148° C. for 9 hr while flowing a mixed gas comprising an ammonia gas, a nitrogen gas and a hydrogen gas at a mixing ratio of 9.5:0.45:0.05 at a total flow rate of 10 L/min. Thereafter, an argon gas was flowed through the reaction system to drop an inside temperature thereof to room temperature at which feed of the argon gas was stopped and the atmosphere was replaced with nitrogen over 3 hr. Next, the resulting specimen was taken out in a glove box directly connected to the reactor.

As a result of XRD, it was confirmed that the resulting particles are constituted of Fe₁₆N₂. Also, it was confirmed that the obtained ferromagnetic iron nitride particles had an average particle major axis length of 2630 nm. Further, it was confirmed that the ferromagnetic iron nitride particles had a saturation magnetization of 218 emu/g as measured at 5 K in a magnetic field of 14.5 kOe.

In Comparative Example 2-1, a total time of the reducing treatment and the nitridation treatment (including a temperature rise time and a cooling-down time) was 29.5 hr, i.e., a prolonged time was required. In addition, the ammonia gas was used, and it was therefore difficult to control a flow rate thereof.

### INDUSTRIAL APPLICABILITY

In the process for producing ferromagnetic iron nitride particles according to the present invention, it is possible to readily obtain the ferromagnetic iron nitride particles, in particular, fine ferromagnetic iron nitride particles. Therefore, the production process of the present invention is suitable as a process for producing ferromagnetic iron nitride particles.

1. A process for producing ferromagnetic iron nitride particles, comprising the steps of:
mixing metallic iron or an iron compound with a nitrogen-containing compound; and
then subjecting the resulting mixture to heat treatment.

2. The process for producing ferromagnetic iron nitride particles according to claim 1, wherein the metallic iron is mixed with the nitrogen-containing compound, and the metallic iron has an average particle major axis length of 5 to 300 nm.

3. The process for producing ferromagnetic iron nitride particles according to claim 2, wherein the metallic iron is obtained by mixing at least one compound selected from the group consisting of a metal hydride, a metal halide and a metal borohydride with the iron compound, and then subjecting the resulting mixture to heat treatment.

4. The process for producing ferromagnetic iron nitride particles according to claim 2, wherein the metallic iron is coated with a silica layer having a thickness of not more than 20 nm.

5. The process for producing ferromagnetic iron nitride particles according to claim 1, wherein the iron compound, the nitrogen-containing compound, and a reducing agent are mixed with each other, and then the resulting mixture is subjected to heat treatment.

6. The process for producing ferromagnetic iron nitride particles according to claim 5, wherein a reduction step and a nitridation step of the iron compound are conducted in the same step.

7. The process for producing ferromagnetic iron nitride particles according to claim 5, wherein the at least one compound selected from the group consisting of a metal hydride, a metal halide and a metal borohydride is used as a reducing agent in the reduction step, and the nitrogen-containing compound is used as a nitrogen source in the nitridation step.

8. The process for producing ferromagnetic iron nitride particles according to claim 5, wherein the iron compound is a silica-coated iron compound.

9. A process for producing an anisotropic magnet comprising ferromagnetic iron nitride particles, in which the ferromagnetic iron nitride particles produced by the process as defined in claim 1 are used.

10. A process for producing a bonded magnet comprising ferromagnetic iron nitride particles, in which the ferromagnetic iron nitride particles as defined in claim 1 are used.

11. A process for producing a compacted magnet comprising ferromagnetic iron nitride particles, in which the ferromagnetic iron nitride particles produced by the process as defined in claim 1 are used.
